(19) United States
(12) Patent Application Publication
(10) Pub. No.: US 2002/0080807 A1
(43) Pub. Date: Jun. 27, 2002

(54) Systems and methods for queue-responsible node designation and queue-handling in an IP network

(76) Inventor: Carina Maria Lind, Mountain View, CA (US)

Correspondence Address: Michael T. Konczal, Navarro IP Law Group, Suite 655, 801 E. Campbell Rd., Richardson, TX, 75081, US

(21) Appl. No.: 09/742,177

(22) Filed: Dec. 22, 2000

(51) Int. Cl. H04J 1/16; H04J 3/14

(52) U.S. Cl. 370/412; 370/352; 370/216

(57) ABSTRACT

The methods and systems disclose the designation of a master node from a plurality of network nodes (24, 26, 28) based on node IP addresses, (32, 34, 36) maintaining a master queue (70) at the master node (26), designating slave nodes (24, 28), and providing copies of the master queue (70) as backups (72, 74). The invention allows for flexibility in the addition and removal of nodes or groups of nodes to and from a network without interruption of the queuing capabilities of the network.

### TECHNICAL FIELD

This invention relates in general to telecommunication networks and applications and, in particular, to methods and systems for managing access to network resources in a telecommunication network. More particularly, the invention relates to methods and systems for dynamic and redundant designation of a queue-responsible node in an IP network.

### BACKGROUND OF THE INVENTION

Computer networks facilitate the sharing of resources, such as hardware, software, communication links, and databases, for example. By distributing workload over many nodes in a network, information processing and communication resources can be optimized. Internet Protocol (IP) networks have been found to be particularly advantageous for distributing resources among nodes in a network. Network topologies are numerous and induce Wide Area Network(s) (WAN), Local Area Network(s) (LAN) and, most recently, the Virtual Local Area Network(s) (VLAN).

Because of the advantages of an IP network, there is a movement toward enterprise-wide VLAN networks in which the entire resources of the network appear to be locally resident at a user's desktop terminal or computer. The trend toward virtual networks has focused much attention in the related arts on addressing problems associated with establishing robust and efficient IP network environments. An inherent problem in implementing any network is that master process failure necessarily leads to the failure of slave processes.

When traffic attempting to cross any given interface or attempting to access any given network resource exceeds the interface's or resource's capacity, queuing is necessary. Queuing is generally defined as holding a sequence of messages or tasks in auxiliary storage awaiting transmission or processing. Many queuing techniques are known in the arts. For example, First-In-First Out (FIFO), wherein queue items are processed in the order received; or precedence queuing, wherein a priority system is used to establish the processing order. These and other queuing techniques can be used in different queuing schemes such as single queuing, in which a single queue is used for all queue items. Another scheme known as multiple queuing uses a different queue for each specific network resource destination.

Regardless of the queuing technique and scheme used, a common practice in the art is to use a dedicated node as a queue node for a network. The queue is generally maintained and controlled by the queue node according to hard-coded instructions or configurations built into the network. A significant problem in the art is that any technical problems experienced at the queue node tend to lead to problems in nodes with queue items waiting to be processed.

Problems exist with queue-handling systems which rely on hard-coding or configuring how queue information is stored and maintained. Queue-handling systems known in the art that are hard-coded or configuration-dependent are at a particular disadvantage in distributed networks wherein all nodes must be updated with queue-handling information. Changes in the network can necessitate reconfiguration in order to implement changes to the queuing system, commonly resulting in an interruption of service. Another disadvantage with the current state of the art is that when maintaining a queue at a particular node, the queue becomes inaccessible if the node is disconnected, resulting in lost information or disruption of service for the remaining nodes.

### SUMMARY OF THE INVENTION

Disclosed are methods for designating a queue-responsible node in an Internet Protocol (IP) network having a plurality of nodes. The methods make use of the IP addresses of the network nodes to designate a master node. Also utilizing the node IP addresses, all other nodes are designated as slave nodes. Queue positions of all nodes in the network are maintained in a master queue at the master node.

The invention disclosed provides many advantages by detecting changes in the number and identity of nodes connected to an IP network and thereupon executing the method of utilizing the IP addresses of the nodes on the network to designate a master node and slave nodes, and maintaining a master queue at the master node.

Also disclosed is a system for queue-handling in an IP network having a plurality of nodes. The system provides software for designating a master node and one or more slave nodes according to the IP addresses of the nodes connected to the network at any given time. Software is also provided for detecting changes in the number and identity of nodes connected to the network. A master queue is provided at the master node for maintaining queue positions of all nodes in the network.

According to another embodiment of the invention, disclosed is a system for queue-handling in an IP network having multiple clusters, each cluster, in turn, having multiple nodes. At least one node of each cluster network is a master node and the remaining nodes are slave nodes. A master queue at the master node maintains queue positions of all nodes in the cluster. Software dynamically designates the master node and said slave nodes according to the IP addresses of the nodes connected to the cluster at any given time. Software is also provided for detecting changes in the number and identity of nodes connected to the cluster.

A technical advantage of the invention is that whenever a node is disconnected or a new node is added to the network, dynamic allocation of a master node is provided, assuring the continued maintenance of the queue without interruption.

Another technical advantage of the invention is that whenever the master node is disconnected, a new master node is dynamically designated and the items in the queue retain their queue positions.

Yet another technical advantage of the invention is that master queue backups are automatically maintained at one or more of the slave nodes.

Still another technical advantage of the invention is that queue designation is practiced independently in clusters that become disconnected from the remainder of a network.

Further technical advantages are realized by the invention in increasing robustness and efficiency in queue-handling in a distributed network environment.

### BRIEF DESCRIPTION OF THE DRAWINGS

The above advantages, as well as specific embodiments of the present invention, will be more clearly understood from consideration of the following descriptions in connection with accompanying drawings in which:

FIG. 1 is a block diagram illustrating an example of a Virtual Local Area Network (VLAN) in which the invention can be practiced;

FIG. 2 is a block diagram illustrating an example of the use of the invention in a cluster within an IP network;

FIG. 3 is a process flow diagram of the method of the example depicted in FIG. 2;

FIG. 4 is a block diagram illustrating an example of the use of the invention in an IP network cluster upon the addition of nodes to the cluster;

FIG. 5 is a process flow diagram of the method of the example of FIG. 4;

FIG. 6 is a block diagram illustrating an example of the use of the invention in an IP network cluster upon the removal of nodes from the cluster;

FIG. 7 is a process flow diagram of the method of the example of FIG. 6; and

FIG. 8 is a block diagram elaborating on the examples of FIGS. 6 and 7, depicting an example of the use of the invention in an IP network cluster which has become disconnected from its original cluster.

Corresponding numerals and symbols in the various figures refer to corresponding parts unless otherwise indicated.

### DETAILED DESCRIPTION OF PREFERRED EMBODIMENTS

While the making and using of various embodiments of the present invention are discussed in detail below, it should be appreciated that the present invention provides many applicable inventive concepts which can be embodied in a wide variety of specific contexts. It should be understood that the invention may be practiced with IP networks and queues of various types and sizes, usually much larger than those shown. Some features of embodiments shown and discussed are simplified or exaggerated for illustrating the principles of the invention.

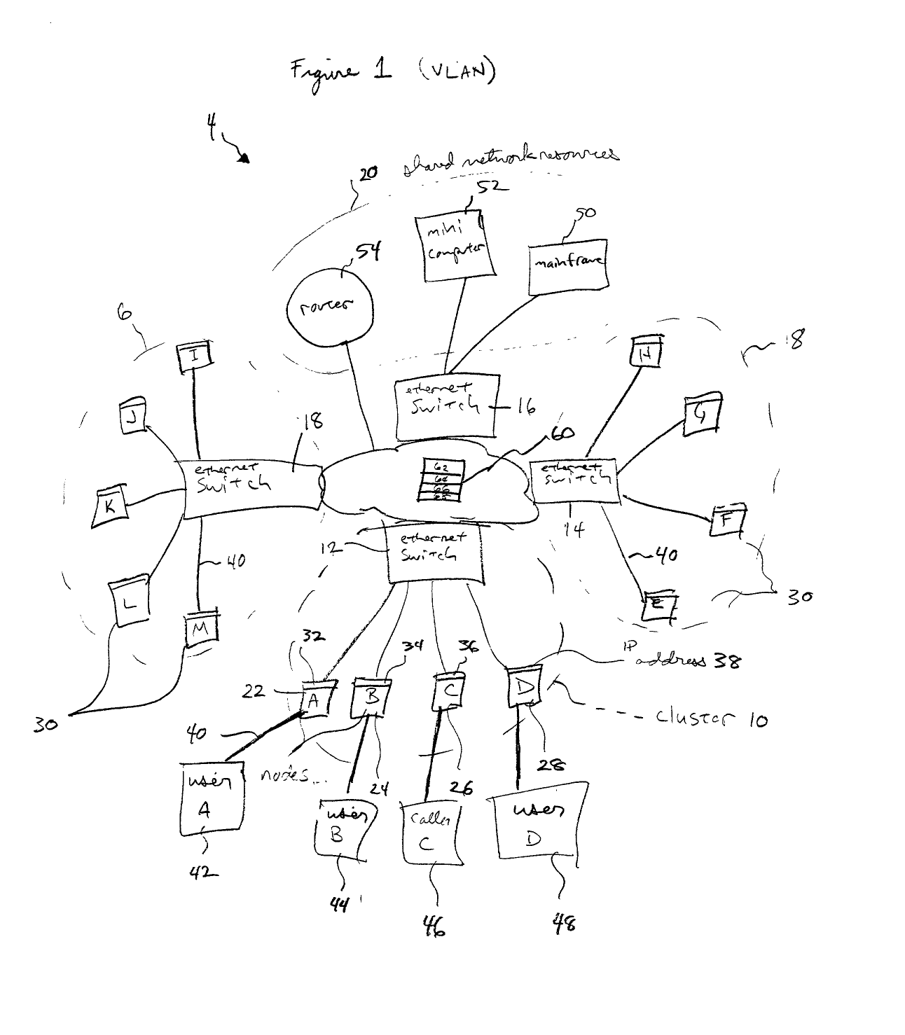

FIG. 1 is a diagram of a Virtual Local Area Network (VLAN) 4 in which the invention may be practiced. The VLAN 4 divides the entire network domain into separate broadcast domains according to functions and traffic patterns as known in the art. The VLAN 4 may be divided into clusters 6, 8, and 10, as in this example. By their connection to individual Ethernet switches 12, 14, 16, and 18, the various nodes of the clusters 6, 8, 10, can gain access to shared network resources 20.

Examining cluster 10 more closely, each node, here denoted node A 22, node B 24, node C 26 and node D 28, has an IP address. Address 32 corresponds to node A 22, address 34 corresponds to node B 24, address 36 corresponds to node C 26, and address 38 corresponds to node D 28. Callers or IP users, simply referred to as “users” herein for convenience, may gain access to shared network resources 20 or communication links 40 among neighboring nodes through their respective node connections. User A 42 is connected to cluster 10, and VLAN 4, through node A 22. User B 44 is connected through node B 24. User C 46 is connected through node C 26. And User D 48 is connected through node D 28. Similar connections are possible for nodes E through M 30 depicted in FIG. 1.

The shared network resources 20 of the VLAN 4 typically include hardware such as a mainframe 50, a minicomputer 52 and a router 54. Typically, the demand for shared network resources 20 placed upon the VLAN 4 by users, in this example user A 42, user B 44, user C 46 and user D 48, simultaneously require access to shared network resources 20. Correspondingly, queue position A 62, queue position B 64, queue position C 66, and queue position D 68, are maintained in a queue 60 to await allocation of shared network resources 20. Various queuing techniques known in the arts such as FIFO or precedence queuing may be used. Although the use of the present invention is described in the context of a VLAN topology, it should be understood that the invention may be used in other IP networks, such as LANs or WANs, as well.

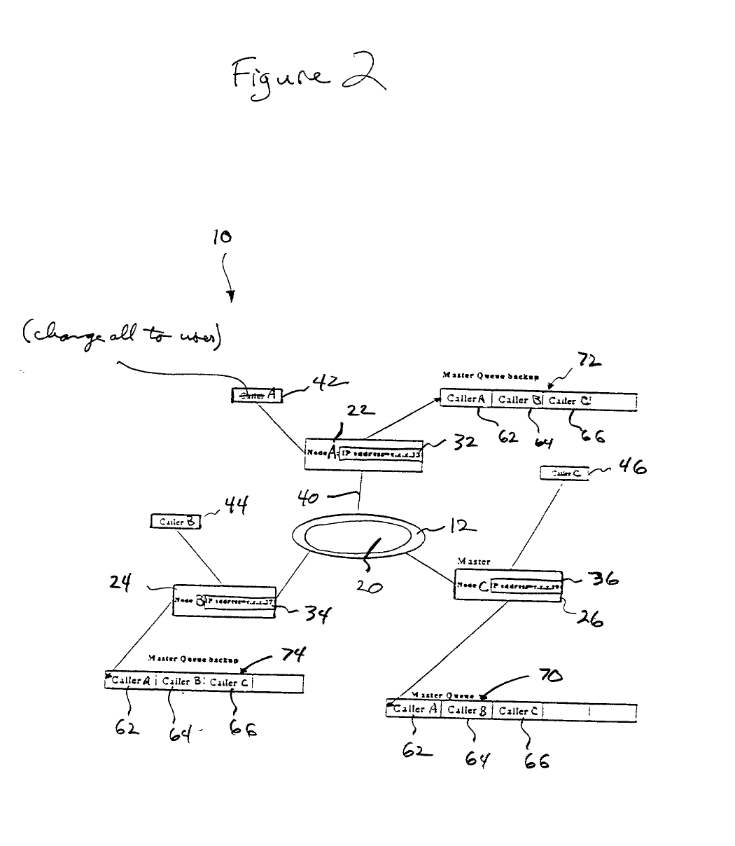

To better understand the use of the invention, reference is made to FIG. 2, which illustrates a snapshot of three nodes with three queued positions in a VLAN cluster 10. For convenience of description, the operation of the invention is described in the context of cluster 10. It should be understood that the concepts of the invention are equally applicable in a more typically complex IP network having a number of clusters such as the VLAN 4 shown in FIG. 1. One of the advantages of the invention is its scalability for use in large or small scale networks.

The network, represented by cluster 10 in this example, is made up of three nodes: node A 22; node B 24; and node C 26. Each of nodes A 22, B 24, and C 26 is identified by a unique IP address: node address A 32; node address B 34; and, node address C 36. In this example, three users are linked to shared network resources 20 through each respective node. User A 42 is connected to the cluster 10 through node A 22. User B 44 is connected to the cluster 10 through node B 24 and user C 46 is connected to the cluster 10 through node C 26. The sharing of common network resources 20 among users, in this example, user A 42, user B 44, and user C 46, is controlled by queuing. As used herein, “queuing” means the sequencing of messages or jobs awaiting transmission or processing. Of course, the common network resources 20 may be Voice over IP (VolP) links, data server access, or other transmission or processing resources in an IP, and are typically accessed through a switch 12.

Further referring to FIG. 2, a master queue 70 is created and maintained at node C 26 based on its IP address 36 as described below. Preferably, the system of the invention is configured to sort IP addresses according to numerical value. In this instance, the system of the invention selects node C 26 to be the master node based on a determination that node C 26 has a higher IP address 36 than remaining nodes, node A 22, and node B 24, which correspondingly have lower IP addresses 32, 34. Of course, those skilled in the art will readily appreciate that different sorting methodologies could be used as long as a unique IP address is determined for designation as the master node. For example, the lowest IP address may be used.

As further discussed below, it is particularly advantageous for the selection methodology to be readily repeatable with any possible combination of nodes in a network. Master queue backups A 72, and B 74 are created at the lower IP address node A 22, and node B 24 respectively. It should be born in mind that the invention is described herein in the context of a cluster 10 for the sake of simplification. It should be understood that the description is equally applicable to larger clusters and IP networks containing multiple clusters, such as the VLAN 4 of FIG. 1 and other IP networks, for example, large-scale LANs and enterprisewide WANs.

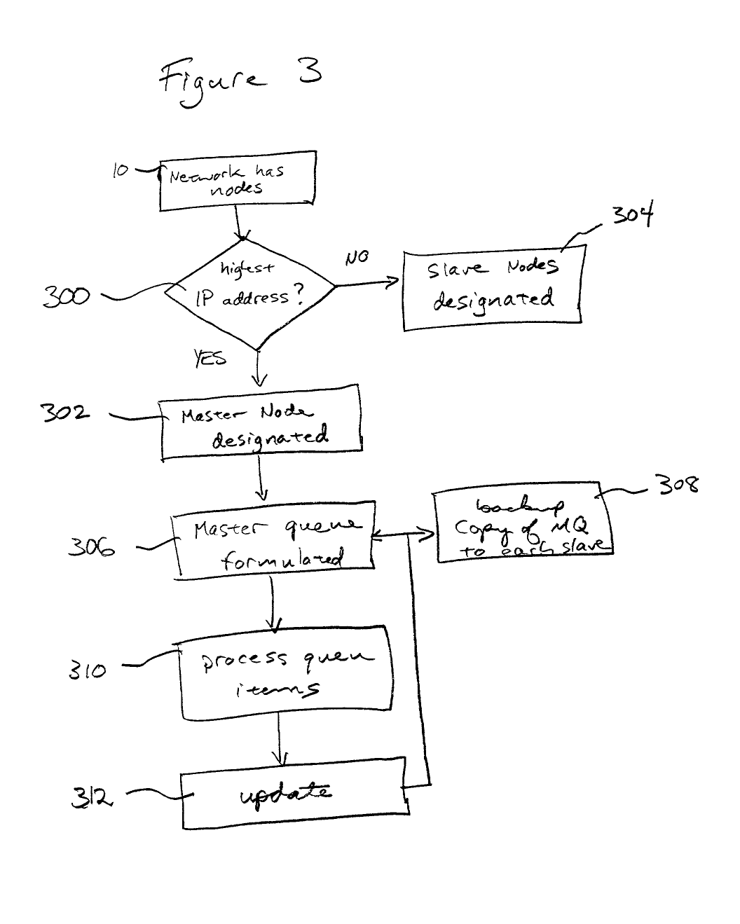

FIG. 3 is a process flow diagram of the queue-responsible node assignment system and methods of the present invention as shown and described with respect to the example of FIG. 2, wherein a cluster 10 with a plurality of nodes is used to represent an IP network. At step 300, the IP addresses of all nodes on the cluster 10 are compared. At step 302, a particular node, preferably that having the highest IP address, is designated the master node. At step 304, each node that is not designated the master node is designated a slave node. At step 304, a master queue is established and maintained at the master node designated in step 302. At step 306, the master queue is formulated. At step 308, copies of the master queue are distributed to all slave nodes. At step 310, queue items are processed according to the preprogrammed instructions of the particular network queuing mechanism.

It should be understood that various queue processing schemes may be used without altering the concept of the invention. For example, FIFO, precedence queuing, single queue or multiple queue schemes may be used. At step 312, the master queue and master queue backups, of steps 306 and 308 respectively, are updated as the queue items are processed. Preferably, at predetermined time intervals or upon the occurrence of predetermined triggering events the steps may reiterate beginning with step 300.

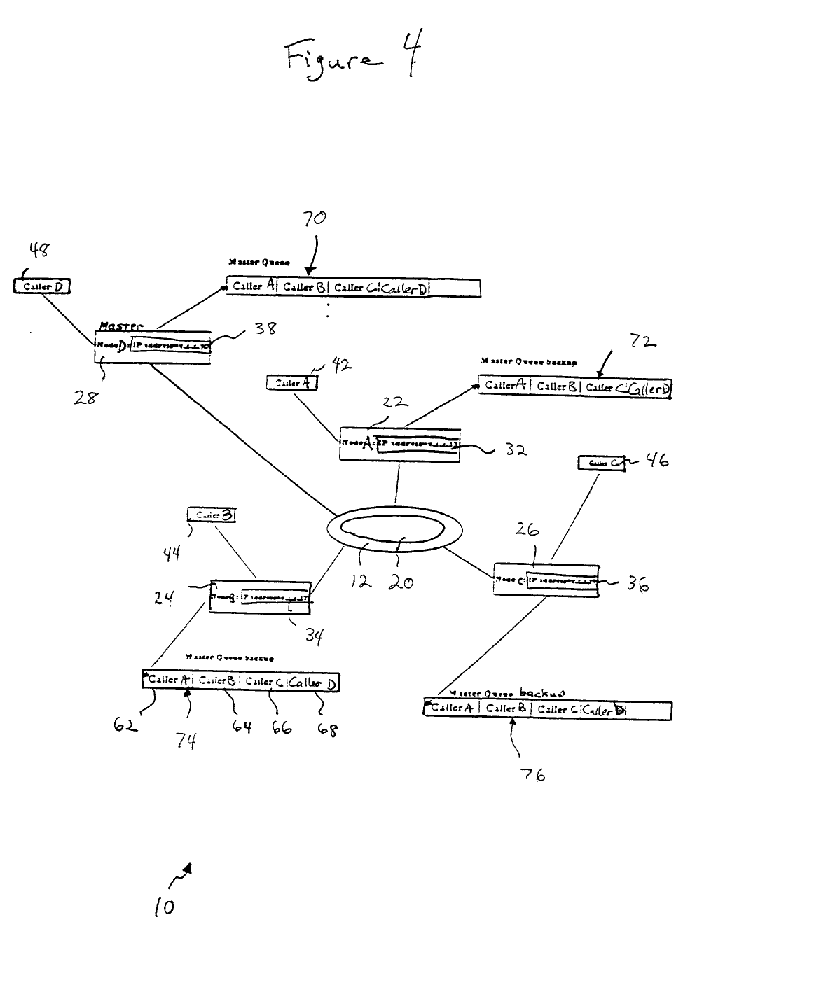

One example of an event that may be used advantageously to trigger a reiteration of the method of the invention is the addition of a new node to the IP network, or continuing in the same vein as the above example, cluster 10. Referring now to FIG. 4, an example of the operation of the invention when a node D 28 is added to the cluster 10 is shown. The addition of node D 28 to the cluster 10 connects user D 48 and places user D 48 into the master queue 70 awaiting access to shared network services 20. Upon entry into the cluster 10, node D 28 has a network IP address 38. In this example, IP address 38 is higher than IP address 36 corresponding to node C 26.

Recall that node C 26 was designated the master node in the above discussion of FIG. 2. Thus, according to the methodology of the embodiment described with respect to FIG. 2, node D 28 is designated the master node. The master queue 70 is maintained at node D 28. Node C 26 is designated a slave node and retains a copy of the master queue 70 as a master queue backup 44. It will be clear to those skilled in the art that, in principle, any number of additional nodes could be added to the network in a similar fashion, either individually or in a cluster. In the event a cluster is added to the network, a merger of the cluster master queue and network master queue is made according to the steps of the invention upon the designation of the new master queue.

It should be understood that, in the event a newly connected node were to have a lower IP address than the current master node, the new node would be designated a slave node, retaining a master queue backup, and the master queue 70 would not be moved. Any queue items possessed by the added nodes would of course also be added to the master queue.

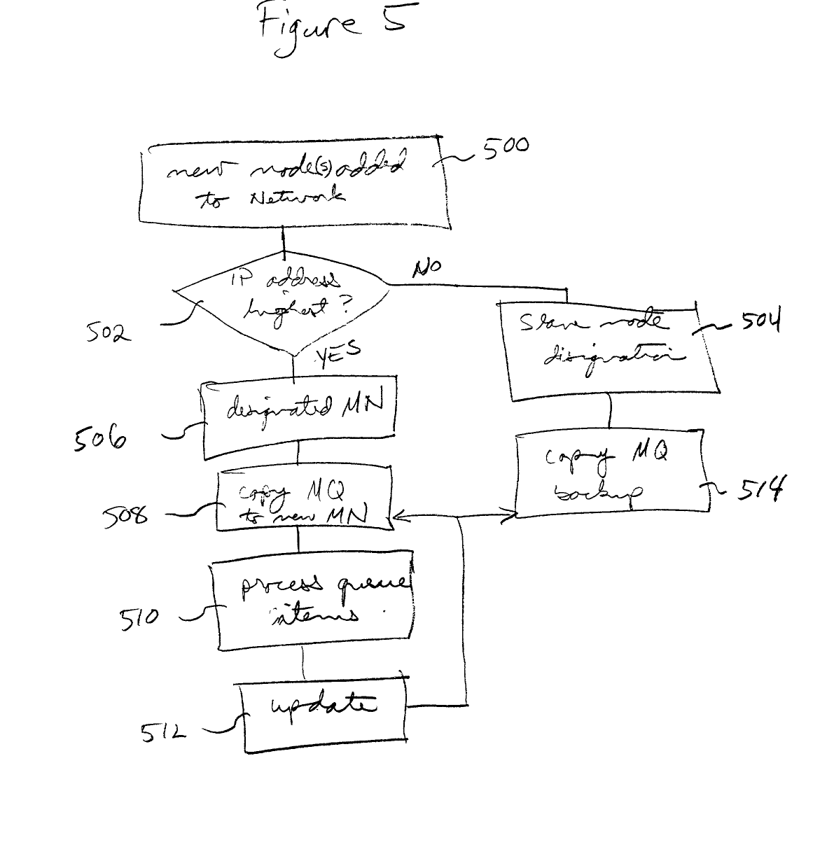

FIG. 5 is a process flow diagram showing the queue-handling method of the present invention as depicted and described with reference to the example of FIG. 4. In step 500, a new node is added to the cluster. Typically, new nodes may be added as part of expanding the network or in reactivating nodes that had been down for repairs, maintenance, or otherwise. In step 502, the IP address of the new node is compared to the IP addresses of existing nodes on the network to make a determination of whether the newly added node is eligible for designation as the master node. In this example, the comparison seeks to determine whether the newly added node had the highest IP address. If the results of the comparison are negative, the new node is designated a slave node in step 504.

In the event that the new node has the highest IP address on the network, it is designated the master node in step 506. In step 508, the master queue is positioned at the master node. In step 510, the master node processes queue items for access to network resources. In step 512, the master queue is updated as the queue items are processed, and the master queue backup at each of the slave nodes is updated in step 514. It is a particular advantage of the invention that a new node can be added to the network without necessitating changes to a hard-coded or configuration-dependent queue management system.

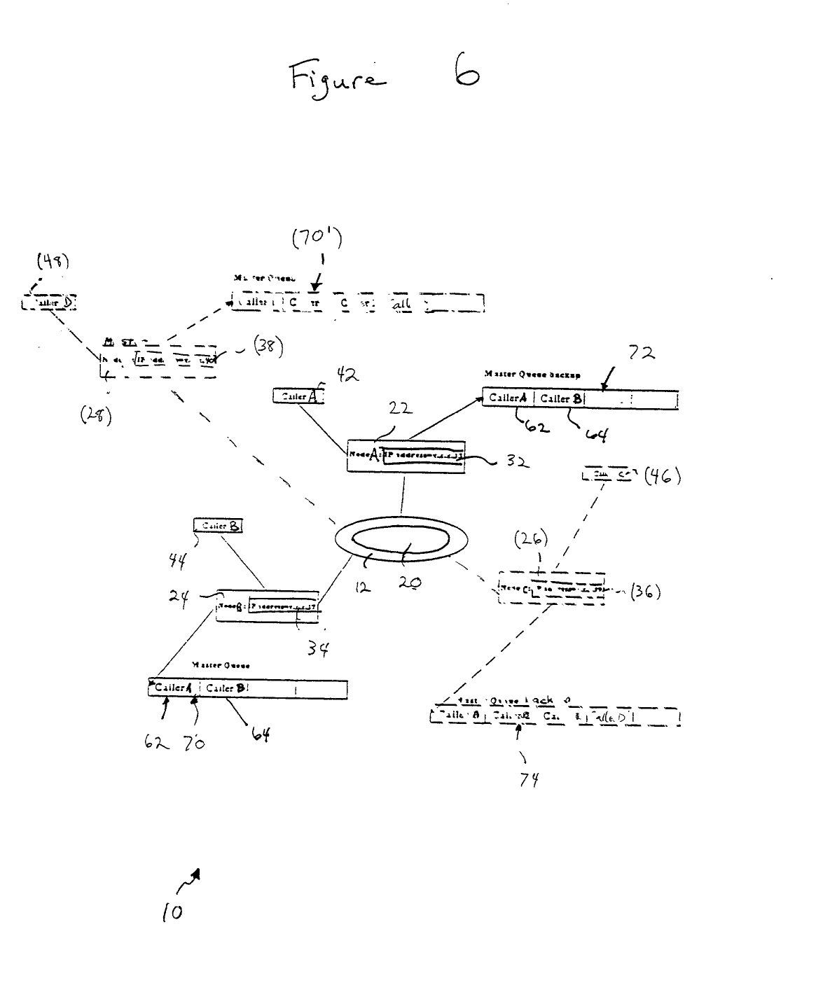

In FIG. 6 is shown an example of the use of the invention when two nodes, node C 26 and node D 28, are disconnected from the network represented by cluster 10. This scenario is another example of an event which may advantageously be used to trigger a reiteration of the method of maintaining the queue, including the technique of designating the master node. In this example, when node D 28 is disconnected, which may occur, for example, under normal cluster 10 operation or due to a malfunction, master queue 70′ ceases to reside at node D 28. A new master node is automatically designated upon a determination that IP address 34 of node B 24 is higher than IP address 32 of node A 22. Thus, node B 24 becomes the master node, master queue backup 74 of node B 24 is automatically transformed into the master queue 70, and node A 22 remains a slave node, continuing to keep a master queue backup 72.

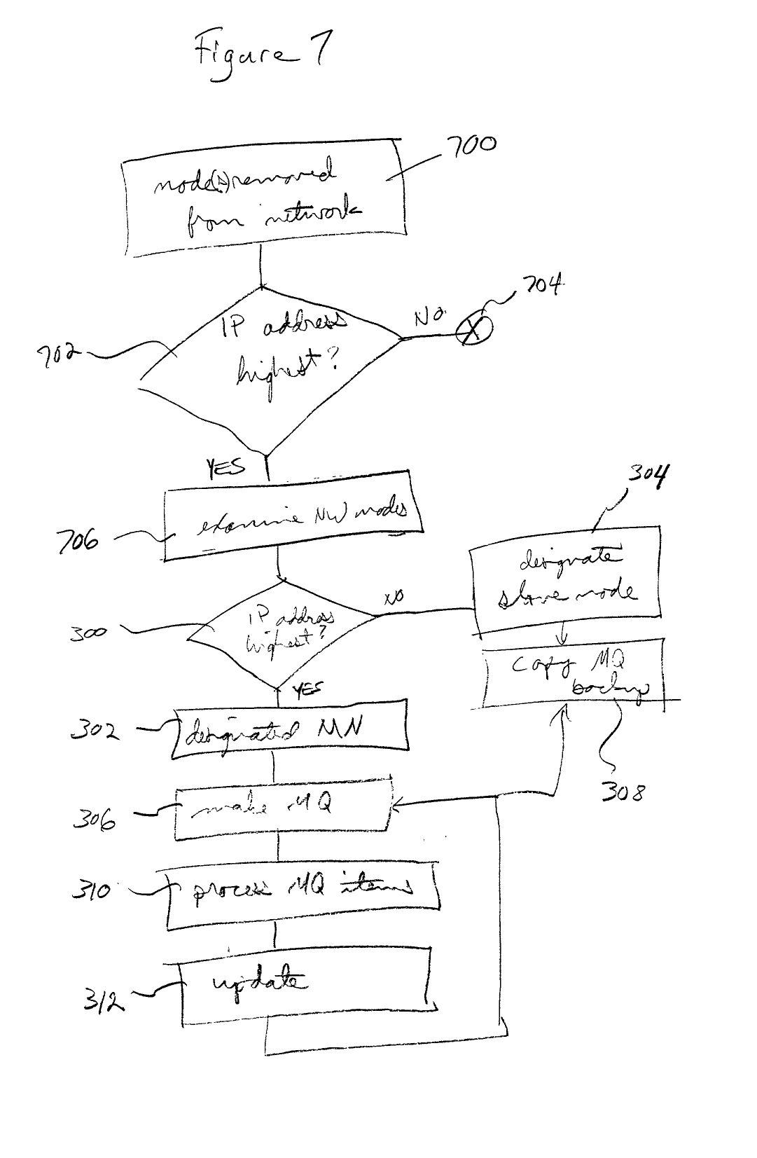

The process flow diagram of FIG. 7 depicts the steps in the process shown and described with reference to FIG. 6 when one or more nodes are, for whatever reason, removed from participation in the network represented by cluster 10. Preferably, in step 700, as one or more nodes are removed from the network and in step 702, it is automatically determined whether the removed node had the highest IP address on the network. If “no,” as shown in branch 704, the system automatically recognizes that a slave node has departed and no further action need be taken. In step 706, it is shown that the departure of the highest IP-addressed node in the network preferably results in the examination of all remaining network nodes to determine the highest IP address. In step 300, the highest IP address is designated the master node and, in step 304, all other nodes are designated slave nodes. The backup master queue in the newly designated master node becomes the new master queue in step 306 and, as shown in step 308, backup copies of the master queue are retained by the slave nodes. In step 310, the master queue continues to process queue items and, in step 312, updates the queue accordingly.

It should be clear from the above examples that in principle, the number of nodes removed from the network is not limited so long as two or more nodes remain in the network. It should also be noted that it is an advantage of the invention that the loss of one or more nodes does not result in the loss of queue information or disruption in service. Of course, the invention may be practiced with less than all slave nodes keeping a copy of the master queue backup. For example, in a large network, it may be desirable to have one master node and a number of slave nodes with master queue backups, according to the above examples, while having still other slave nodes with no master queue backup functionality.

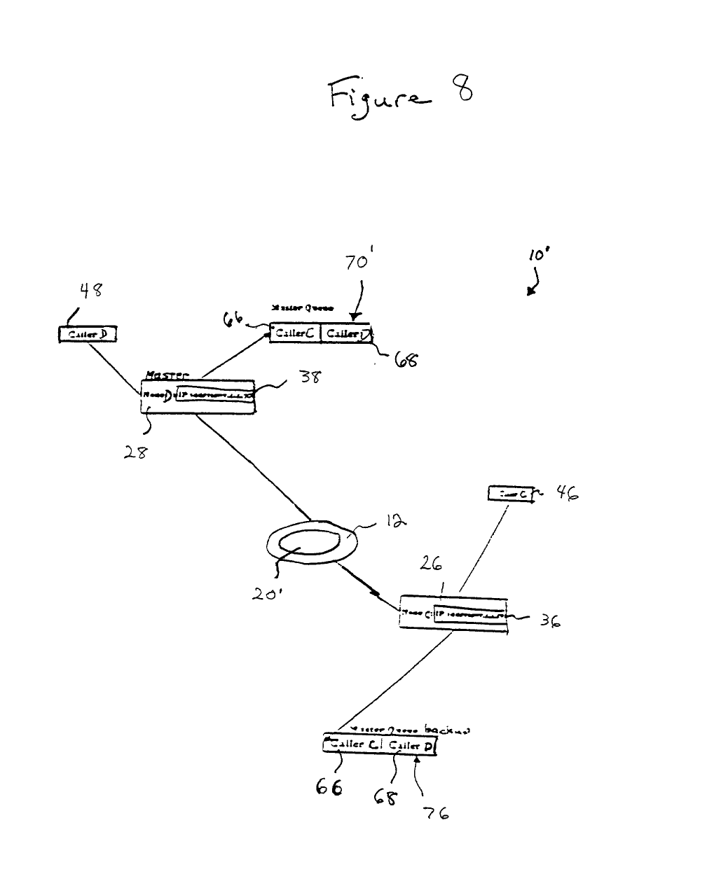

FIG. 8 further illustrates the operation of the invention and the advantageous dynamic master node designation and built-in redundancy of the system and methods of the invention. This example shows that in the event that node C 26 and node D 28 become disconnected from the cluster 10, as shown and described with reference to FIGS. 6 and 7, yet continued to maintain a connection to mutually shared network resources 20′, through Ethernet switch 12′, the invention is also practiced independently with respect to node C 26 and node D 28. In effect, node C 26 and node D 28 form a new cluster 10′ independent of the previous cluster 10 of FIG. 6. Specifically, node D 28, having the higher IP address 38, continues to be the master node with respect to node C 26, which has a lower IP address 36. A master queue 70′ is maintained at master node D 28 and a master queue backup 44 is maintained at node C 26. Of course, the contents of the queues 70, 76 are now limited to queue positions 66, 68 pertaining to user C 46 and user D 48. It should be understood that the events described with respect to FIG. 8 occur contemporaneously with the events described with respect to FIGS. 6 and 7. Thus, one of the advantages of the invention is the ability to maintain and manage a queue when the structure of the network changes. As illustrated in this example, the invention is able to treat clusters which become disconnected from the original network as ad hoc networks without losing their queue information.

Preferred implementations of the invention include implementations to execute the systems and methods described herein as a software-implemented program product residing in a memory of a microcomputer. Until required by a microcomputer, the set of instructions may be stored as a program product in computer memory. For example, the set of instructions may be stored as a program product in a disk drive attached to a microcomputer, which may include a removable memory such as an optical disk or floppy disk for eventual use in the disk drive. A software-implemented program product of the invention as described herein may further include editing means known in the art for permitting a user of the program product to write, edit, and store the logic means for implementing the invention as instructions in a machine-readable language for carrying out the steps of the invention.

It will be appreciated that the present invention provides several advantages in increasing the flexibility and reliability of IP network operations. The queue-handling in the IP network is accomplished without hard-coding or configuring dedicated hardware to establish and maintain a queue. This facilitates continuation of queue operations even as network hardware is added to or removed from the network. Additional advantages in reliability are realized by the creation of redundant master queue backups.

what is claimed is:

1. In an Internet Protocol (IP) network having a plurality of nodes, a method of designating a queue-responsible node comprising the steps of:
(a) utilizing the IP addresses of said plurality of nodes to designate a master node;
(b) designating all other nodes as slave nodes; and
(c) maintaining the queue positions of all nodes in the network in a master queue at said master node.

2. The method of claim 1 wherein said designating steps are performed by comparing numerical values of node IP addresses.

3. The method of claim 1 wherein the node having the highest IP address is designated said master node.

4. The method of claim 1 wherein the node having the lowest IP address is designated said master node.

5. The method of claim 1 wherein each node of the network is capable of functioning as either said master node or one of said slave nodes.

6. The method of claim 1 further comprising the step of maintaining a copy of said master queue at one or more of said slave nodes.

7. The method of claim 6 wherein said step of maintaining a copy of said master queue is performed at each of said slave nodes.

8. The method of claim 1 further comprising the step of each slave node requesting a queue position from said master node for access to shared network resources.

9. The method of claim 1 further comprising the step of detecting the connection of one or more additional nodes to the network and thereupon reiterating said steps (a) through (c).

10. The method of claim 1 further comprising the step of detecting the disconnection of one or more nodes from the network and thereupon reiterating said steps (a) through (c).

11. The method of claim 10 further comprising the step of deleting from said master queue all queue positions corresponding to said disconnected nodes.

12. In an Internet Protocol (IP) network having a plurality of nodes, a method of designating a queue-responsible node comprising the steps of:
(a) utilizing the IP addresses of said plurality of nodes to designate a master node;
(b) designating all other nodes as slave nodes;
(c) maintaining the queue positions of all nodes in the network in a master queue at said master node;
(d) detecting changes in the number and identity of nodes connected to the network and thereupon reiterating steps (a) through (c).

13. The method of claim 12 wherein step (d) comprises detecting the disconnection of the master node from the network.

14. The method of claim 12 wherein step (d) comprises detecting the connection of one or more additional nodes to the network.

15. The method of claim 12 wherein step (d) comprises detecting the disconnection of one or more slave nodes from the network, further comprising the step of deleting from the master queue all queue positions corresponding to said one or more disconnected slave nodes.

16. A system for queue-handling in an Internet Protocol (IP) network having a plurality of nodes, comprising:
a master node;
a master queue at said master node for maintaining queue positions of all nodes in the network;
one or more slave nodes;
software for designating said master node and said one or more slave nodes according to the IP addresses of the nodes connected to the network at any given time; and
software for detecting changes in the number and identity of nodes connected to the network.

17. The system of claim 16 further comprising software associated with one or more of said slave nodes for maintaining a copy of said master queue at said one or more slave nodes.

18. The system of claim 16 further comprising software associated with each of said nodes for maintaining a copy of said master queue at each of said slave nodes.

19. The system of claim 16 wherein the network comprises a Local Area Network (LAN).

20. The system of claim 16 wherein the network comprises a Virtual Local Area Network (VLAN).

21. The system of claim 16 wherein the network comprises a Wide Area Network (WAN).

22. The system of claim 16 wherein the network comprises a cluster within an area network.

23. A system for queue-handling in an Internet Protocol (IP) network comprising at least a first cluster and a second cluster, each cluster further comprising:
a plurality of nodes with at least one of said nodes being a master node and the remaining nodes being slave nodes;
a master queue at said master node for maintaining queue positions of all nodes in the cluster;
software means for dynamically designating said master node and said slave nodes according to the IP addresses of the nodes connected to the cluster at any given time; and
software for detecting changes in the number and identity of nodes connected to the cluster.

24. The system of claim 23 further comprising software associated with one or more of said slave nodes in each cluster for maintaining a copy of said master queue at said one or more slave nodes in each cluster.

25. The system of claim 23 further comprising software associated with each of said slave nodes for maintaining a copy of said master queue at each of said slave nodes.

26. The system of claim 23 wherein the network comprises a Local Area Network (LAN).

27. The system of claim 23 wherein the network comprises a Virtual Local Area Network (VLAN).

28. The system of claim 23 wherein the network comprises a Wide Area Network (WAN).
